(19) United States
(12) Patent Application Publication
(10) Pub. No.: US 2025/0239179 A1
(43) Pub. Date: Jul. 24, 2025

(54) PROPORTIONAL VALVES FOR PATIENT SIMULATORS

(71) Applicant: GAUMARD SCIENTIFIC COMPANY, INC., Miami, FL (US)

(72) Inventors: Julio FERRER, Miami, FL (US); Arian HERNANDEZ, Miami, FL (US)

(21) Appl. No.: 19/029,712

(22) Filed: Jan. 17, 2025

Related U.S. Application Data
(60) Provisional application No. 63/622,762, filed on Jan. 19, 2024.

(51) Int. Cl. G09B 23/30

(52) U.S. Cl. CPC G09B 23/303

(57) ABSTRACT

Proportional valves for patient simulators and associated devices, systems, and methods are provided. In some instances, a patient simulator comprises: a simulated portion of a human body; and a proportional valve assembly positioned within the simulated portion of the human body, the proportional valve assembly including a resiliently deformable valve and a displacement assembly, wherein the displacement assembly is configured to selectively compress the resiliently deformable valve to control a flow of fluid and/or gas through the resiliently deformable valve.

### CROSS-REFERENCE TO RELATED APPLICATIONS

The present application claims priority to and the benefit of U.S. Provisional Patent Application No. 63/622,762, filed Jan. 19, 2024, which is hereby incorporated by reference in its entirety for all applicable purposes.

### INTRODUCTION

The present disclosure relates generally to patient simulators. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. Pat. No. 11,756,451, U.S. Pat. No. 8,696,362, U.S. Pat. No. 8,016,598, U.S. Pat. No. 7,976,312, U.S. Pat. No. 7,976,313, U.S. patent application Ser. No. 11/952,669 (Publication No. 20090148822), U.S. Pat. No. 7,114,954, U.S. Pat. No. 6,758,676, U.S. Pat. No. 6,503,087, U.S. Pat. No. 6,527,558, U.S. Pat. No. 6,443,735, U.S. Pat. No. 6,193,519, and U.S. Pat. No. 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

This disclosure describes proportional valves for patient simulators. In this regard, the proportional valves of the current disclosure can provide a better range of control with reduced turbulence and noise with lower power requirements as compared to traditional needle valves. As a result, the proportional valves of the present disclosure can provide more realistic simulations in the context of patient simulators by reducing and/or eliminating unwanted, unexpected, or unnatural noises and/or reduce power consumption (extending battery life and operating times for the patient simulator).

In some aspects, a proportional valve assembly comprises a resiliently deformable valve with an inlet and an outlet, and a displacement assembly configured to selectively compress the resiliently deformable valve between the inlet and the outlet to control a flow of fluid and/or gas through the resiliently deformable valve. The resiliently deformable valve may be configured to provide a linear response in terms of the flow of the fluid and/or the gas to the amount of compression of the resiliently deformable valve. The resiliently deformable valve may include a plurality of openings extending along its length. The displacement assembly may be further configured to selectively compress the plurality of openings when compressing the resiliently deformable valve. The displacement assembly may comprise a linear actuator and an engagement structure. The linear actuator may be configured to control displacement of the engagement structure to selectively compress the plurality of openings through contact of the engagement structure with the resiliently deformable valve. The proportional valve assembly may further comprise a control unit in communication with the displacement assembly. The linear actuator may be controlled at least in part based on a communication from the control unit. Additionally, the proportional valve assembly may include a mounting structure to which the resiliently deformable valve and the displacement assembly are coupled. The mounting structure may include an additional engagement structure configured to compress the plurality of openings through contact of the additional engagement structure with the resiliently deformable valve opposite the engagement structure of the displacement assembly. The resiliently deformable valve can be formed of rubber, silicone, and/or other suitable resiliently deformable materials.

Patient simulators and/or associated methods incorporating the proportional valve assemblies of the present disclosure are also provided. In some aspects, a patient simulator, comprises: a simulated portion of a human body; and a proportional valve assembly positioned within the simulated portion of the human body. The proportional valve assembly may include a resiliently deformable valve and a displacement assembly. The displacement assembly may be configured to selectively compress the resiliently deformable valve to control a flow of fluid and/or gas through the resiliently deformable valve. The resiliently deformable valve may be configured to provide a linear response in terms of the flow of the fluid and/or the gas through the resiliently deformable valve to the amount of compression of the resiliently deformable valve. The resiliently deformable valve may include a plurality of openings extending along a length of the resiliently deformable valve. The displacement assembly may be further configured to selectively compress the plurality of openings when compressing the resiliently deformable valve. The displacement assembly may comprise a linear actuator and an engagement structure. The linear actuator may be configured to control displacement of the engagement structure to selectively compress the plurality of openings through contact of the engagement structure with the resiliently deformable valve. The patient simulator may further comprise a control unit in communication with the displacement assembly. The linear actuator may be controlled at least in part based on a communication from the control unit. The patient simulator may further comprise a mounting structure. The resiliently deformable valve and the displacement assembly may be coupled to the mounting structure. The mounting structure may include an additional engagement structure configured to compress the plurality of openings through contact of the additional engagement structure with the resiliently deformable valve opposite the engagement structure of the displacement assembly. The resiliently deformable valve may be formed of a rubber, a silicone, or other suitable resiliently deformable materials.

In some aspects, a method comprises selectively compressing a resiliently deformable valve positioned within a patient simulator to control a flow of fluid and/or gas through the resiliently deformable valve. The resiliently deformable valve may be configured to provide a linear response in terms of the flow of the fluid and/or the gas through the resiliently deformable valve to the amount of compression of the resiliently deformable valve. The resiliently deformable valve may include a plurality of openings extending along a length of the resiliently deformable valve such that the plurality of openings are compressed when the resiliently deformable valve is selectively compressed. Selectively compressing the resiliently deformable valve may comprise controlling displacement of an engagement structure. The displacement of the engagement structure may be caused by a linear actuator coupled to the engagement structure. The linear actuator may be controlled at least in part based on a communication from a control unit. The communication from the control unit may be based, at least in part, on a medical simulation scenario associated with the patient simulator. Selectively compressing the resiliently deformable valve may be performed based on a medical simulation scenario being executed by the patient simulator.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a patient simulator including a simulated torso, a simulated head, a simulated neck, a simulated right arm, a simulated left arm, a simulated right leg, and a simulated left leg, including at least one proportional valve assembly according to one or more aspects of the present disclosure.

FIG. 2 is a perspective view of a proportional valve assembly, according to one or more aspects of the present disclosure.

FIG. 3 is an exploded view of the proportional valve assembly of FIG. 2, according to one or more aspects of the present disclosure.

FIG. 4 is a perspective view of a mounting structure of the proportional valve assembly of FIGS. 2-3, according to one or more aspects of the present disclosure.

FIG. 5 is a front view of the mounting structure of FIG. 4, according to one or more aspects of the present disclosure.

FIG. 6 is a rear view of the mounting structure of FIGS. 4-5, according to one or more aspects of the present disclosure.

FIG. 7 is an end view of the mounting structure of FIGS. 4-6, according to one or more aspects of the present disclosure.

FIG. 8 is an end view of the mounting structure of FIGS. 4-7 from the opposite end of the view shown in FIG. 7, according to one or more aspects of the present disclosure.

FIG. 9 is an exploded view of a valve connection assembly of the proportional valve assembly of FIGS. 2-3, according to one of more aspects of the present disclosure.

FIG. 10 is a perspective view of a resiliently deformable valve of the valve connection assembly of FIG. 9, according to one of more aspects of the present disclosure.

FIG. 11 is a perspective, longitudinal cross-sectional view of the resiliently deformable valve of FIG. 10, according to one of more aspects of the present disclosure.

FIG. 12 is a perspective, cross-sectional view of the resiliently deformable valve of FIGS. 10-11, according to one of more aspects of the present disclosure.

FIG. 13 is a perspective view of a connector of the valve connection assembly of FIG. 9, according to one of more aspects of the present disclosure.

FIG. 14 is a perspective, longitudinal cross-sectional view of the connector of FIG. 13, according to one of more aspects of the present disclosure.

FIG. 15 is a perspective view of a fitting and O-ring of the valve connection assembly of FIG. 9, according to one of more aspects of the present disclosure.

FIG. 16 is a perspective, longitudinal cross-sectional view of the fitting and O-ring of FIG. 15, according to one of more aspects of the present disclosure.

FIG. 17 is an exploded view of a linear displacement assembly of the proportional valve assembly of FIGS. 2-3, according to one of more aspects of the present disclosure.

FIG. 18 is a front view of a linear displacement actuator of the linear displacement assembly of FIG. 17, according to one of more aspects of the present disclosure.

FIG. 19 is a side view of the linear displacement actuator of FIG. 18, according to one of more aspects of the present disclosure.

FIG. 20 is a side view of an engagement structure of the linear displacement assembly of FIG. 17, according to one of more aspects of the present disclosure.

FIG. 21 is a front view of the engagement structure of FIG. 20, according to one of more aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

One of the aims of healthcare simulation is to establish a teaching environment that closely mimics key clinical cases in a reproducible manner. The introduction of high fidelity tetherless simulators, such as those available from Gaumard Scientific Company, Inc., over the past few years has proven to be a significant advance in creating realistic teaching environments. The present disclosure is directed to a patient simulator that expands the functionality of the simulators by increasing the realism of the look, feel, and functionality of the simulators that can be used to train medical personnel in a variety of clinical situations. The patient simulator disclosed herein offers a training platform on which medical scenarios can be performed for the development of medical treatment skills and the advancement of patient safety. Accordingly, the user's medical treatment skills can be obtained and/or improved in a simulated environment without endangering a live patient. Moreover, the patient simulator allows for multiple users to simultaneously work with the patient simulator during a particular medical scenario, thereby facilitating team training and assessment in a realistic, team-based environment.

In several aspects, the patient simulator includes features designed to enhance the educational experience. For example, in several aspects, the system includes a processing module to simulate different medical and/or surgical scenarios during operation of the patient simulator. In several aspects, the system includes a camera system that allows visualization of the procedure for real-time video and log capture for debriefing purposes. In several aspects, the patient simulator is provided with a workbook of medical scenarios that are pre-programmed in an interactive software package, thereby providing a platform on which medical scenarios can be performed for the development of medical treatment skills and general patient safety. Thus, the patient simulators disclosed herein provide a system that is readily expandable and updatable without large expense and that enables users to learn comprehensive medical and surgical skills through “hands-on” training, without sacrificing the experience gained by users in using standard surgical instruments in a simulated patient treatment situation.

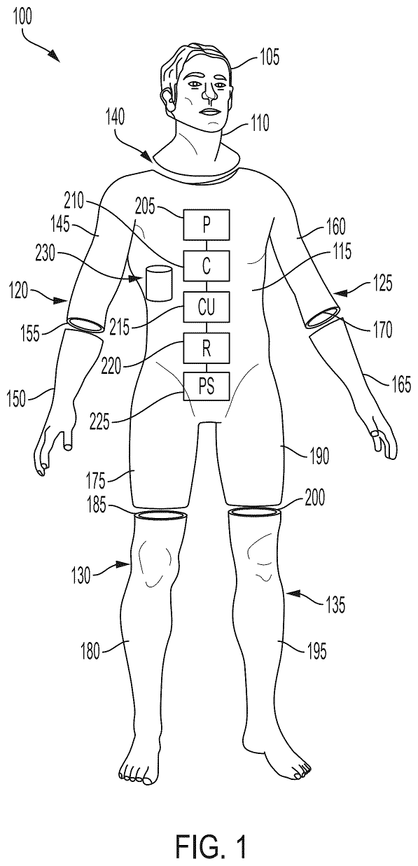

Referring to FIG. 1, in some aspects, a patient simulator is generally referred to by the reference numeral 100 and includes a simulated head 105, a simulated neck 110, a simulated torso 115, a simulated right arm 120 (or “extremity”), a simulated left arm 125 (or “extremity”), a simulated right leg 130 (or “extremity”), and a simulated left leg 135 (or “extremity”). In several embodiments, the patient simulator is, includes, or is part of, a manikin. The simulated head 105 may be coupled to the simulated neck 110. For example, the simulated head 105 may be integrally formed with and/or detachably coupled to the simulated neck 110. The patient simulator 100 may further include a head coupling 140. The simulated neck 110 may be adapted to be detachably coupled to the simulated torso 115 via the head coupling 140. In some aspects, the simulated right arm 120 includes a simulated upper right arm 145 (or “extremity”) and a simulated lower right arm 150 (or “extremity”). The simulated upper right arm 145 may be coupled to the simulated torso 115. For example, the simulated upper right arm 145 may be integrally formed with and/or detachably coupled to the simulated torso 115. The simulated right arm 120 may further include a right arm coupling 155 (or “extremity coupling”). The simulated lower right arm 150 may be detachably coupled to the simulated upper right arm 145 via the right arm coupling 155. Similarly, the simulated left arm 125 may include a simulated upper left arm 160 (or “extremity”) and a simulated lower left arm 165 (or “extremity”). The simulated upper left arm 160 may be coupled to the simulated torso 115. For example, the simulated upper left arm 160 may be integrally formed with and/or detachably coupled to the simulated torso 115. The simulated left arm 125 may further include a left arm coupling 170 (or “extremity coupling”). The simulated lower left arm 165 may be detachably coupled to the simulated upper left arm 160 via the left arm coupling 170.

The simulated right leg 130 may include a simulated upper right leg 175 (or “extremity”) and a simulated lower right leg 180 (or “extremity”). The simulated upper right leg 175 may be coupled to the simulated torso 115. For example, the simulated upper right leg 175 may be integrally formed with and/or detachably coupled to the simulated torso 115. The simulated right leg 130 may further include a right leg coupling 185 (or “extremity coupling”). The simulated lower right leg 180 may be detachably coupled to the simulated upper right leg 175 via the right leg coupling 185. Similarly, the simulated left leg 135 may include a simulated upper left leg 190 (or “extremity”) and a simulated lower left leg 195 (or “extremity”). The simulated upper left leg 190 may be coupled to the simulated torso 115. For example, the simulated upper left leg 190 may be integrally formed with and/or detachably coupled to the simulated torso 115. The simulated left leg 135 may further include a left leg coupling 200 (or “extremity coupling”). The simulated lower left leg 195 may be detachably coupled to the simulated upper left leg 190 via the left leg coupling 200.

In some instances, the simulated torso 115 may be divided into a simulated upper torso and a simulated lower torso. In such instances, the simulated upper right arm 145 and the simulated upper left arm 160 may be coupled to the simulated upper torso. For example, the simulated upper right arm 145 and the simulated upper left arm 160 may be integrally formed with and/or detachably coupled to the simulated upper torso. The simulated upper right leg 175 and the simulated upper left leg 190 may be coupled to the simulated lower torso. For example, the simulated upper right leg 175 and the simulated upper left leg 190 may be integrally formed with and/or detachably coupled to the simulated lower torso. The simulated torso 115 may further includes a torso coupling via which the simulated upper torso may be detachably coupled to the simulated lower torso.

The simulated torso 115 (as well as the simulated head 105, simulated neck 110, simulated right arm 120, simulated left arm 125, a simulated right leg 130, and/or simulated left leg 135) may contain one or more pump(s) 205, compressor(s) 210, control unit(s) 215, reservoir(s) 220, power source(s) 225, proportional valve assembl(ies) 230, and/or other components. The pump(s) 205 may be adapted to supply hydraulic pressure to various features/components of the patient simulator 100. The features/components to which hydraulic pressure is supplied by the pump(s) 205 may be contained in the simulated torso 115, the simulated head 105, the simulated right arm 120, the simulated left arm 125, the simulated right leg 130, and/or the simulated left leg 135. In some instances, the pump(s) 205 may supply hydraulic pressure to one or more of the reservoir(s) 220. For example, the pump(s) 205 may cause fluid to be transferred into and/or out of one or more of the reservoir(s) 220. In this regard, the reservoir(s) 220 may contain fluid and/or gas.

The compressor(s) 210 may be adapted to supply pneumatic pressure to various features/components of the patient simulator 100. The features/components to which pneumatic pressure is supplied by the compressor(s) 210 may be contained in the simulated torso 115, the simulated head 105, the simulated right arm 120, the simulated left arm 125, the simulated right leg 130, and/or the simulated left leg 135. In some instances, the compressor(s) 210 may include a scroll compressor. In some instances, the compressor(s) 210 may supply pneumatic pressure to one or more of the reservoir(s) 220. In this regard, the reservoir(s) 220 may contain fluid and/or gas. In some instances, one or more a proportional valve assemblies 230 be associated with one or more of the pump(s) 205, compressor(s) 210, and/or reservoir(s) 220 to control the flow of fluid and/or gas through various parts of the patient simulator 100 for one or more simulation scenarios.

The control unit(s) 215 may be adapted to control the pump(s) 205, the compressor(s) 210, the reservoir(s) 220, including one or more valves associated with the pump(s), compressor(s), and/or reservoir(s) (e.g., including the proportional valve assembl(ies) 230), and/or various other features/components of the patient simulator 100. The features/components controlled by the control unit(s) 215 may be contained in the simulated torso 115, the simulated head 105, the simulated right arm 120, the simulated left arm 125, the simulated right leg 130, and/or the simulated left leg 135. In some instances, each of the control unit(s) 215 may be associated with one or more functions and/or features of the patient simulator 100.

The reservoir(s) 220 may contain fluid and/or gas for use in simulating one or more scenarios, functions, and/or features. For example, the reservoir(s) 220 may contain simulated bodily fluids (e.g., blood, urine, saliva, tears, etc.) and/or simulated bodily gasses (e.g., air, O₂, CO₂, etc.). The reservoir(s) 220 may include a single compartment or multiple compartments. The reservoir(s) 220 may be associated with one or more valves, including proportional valve assembl(ies) 230, to control the flow of fluid and/or gas into and/or out of the reservoir(s) 220.

The power source(s) 225 may supply electrical power to the pump(s) 205, the compressor(s) 210, the control unit(s) 215, the reservoir(s) 220, including one or more valves associated with the pump(s), compressor(s), and/or reservoir(s) (e.g., the proportional valve assembl(ies) 230), and various other features/components of the patient simulator 100. The features/components to which electrical power is supplied by the power source(s) 225 may be contained in the simulated torso 115, the simulated head 105, the simulated right arm 120, the simulated left arm 125, the simulated right leg 130, and/or the simulated left leg 135. The features/components to which electrical power is supplied by the power source(s) 225 may be contained in a different portion of the patient simulator 100 than the power source(s) 225. In some aspects, the power source(s) 225 includes lithium battery technology that reduces weight, volume, and complexity while providing greater power density. However, any suitable battery technology may be used in accordance with the present disclosure, including without limitation lithium, lithium-ion, lithium-sulfur, lithium manganese oxide, lithium polymer, lithium titanate, lithium cobalt oxide, lithium iron phosphate, nickel metal hydride, nickel-cadmium, alkaline, supercapacitor, sodium-ion, magnesium, etc.

In some instances, the power source(s) 225 may be positioned within one or more extremities (e.g., the simulated right arm 120, the simulated left arm 125, the simulated right leg 130, and/or the simulated left leg 135) of the patient simulator 100. In this regard, an extremity containing the power source(s) 225 may be detachably coupled to the simulated torso 115. In some aspects, the extremity containing the power source(s) 225 may include a quick-connect connector to facilitate simple and/or fast power system changes (e.g., by swapping an extremity with a depleted power source for an extremity with a charged power source). In this regard, the quick-connect connector may physically couple the extremity to the simulated torso 115 and/or another aspect of the patient simulator 100 (e.g., upper and/or lower arm, upper and/or lower leg, etc.). The quick-connect connector may also electrically couple the power source(s) 225 contained in the extremity to one or more components of the patient simulator 100 (e.g., the pump(s) 205, the compressor(s) 210, the control unit(s) 215, the reservoir(s) 220, including one or more valves associated with the pump(s), compressor(s), and/or reservoir(s), and various other features/components). In some aspects, the quick-connect connector may also pneumatically and/or fluidly couple one or more components (e.g., pump(s) 205, compressor(s) 210, reservoir(s) 220, valve(s), and other pneumatic and/or fluid components) contained in the extremity (along with the power source(s) 225) to one or more other components of the patient simulator 100 (e.g., the pump(s) 205, the compressor(s) 210, the reservoir(s) 220, valve(s), and various other features/components).

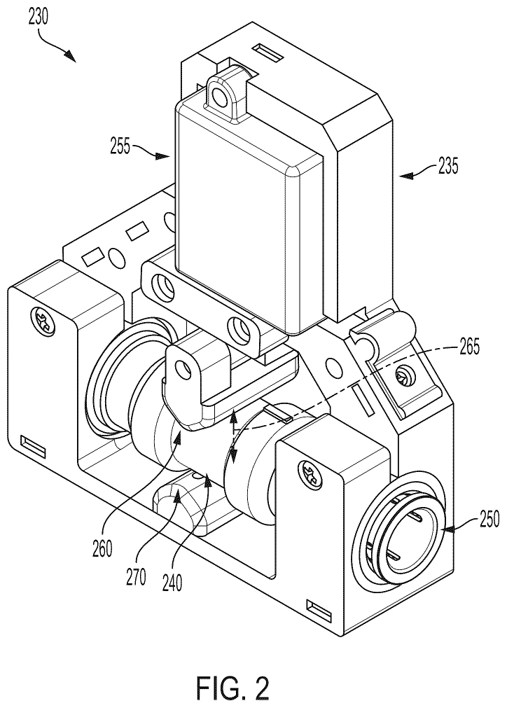

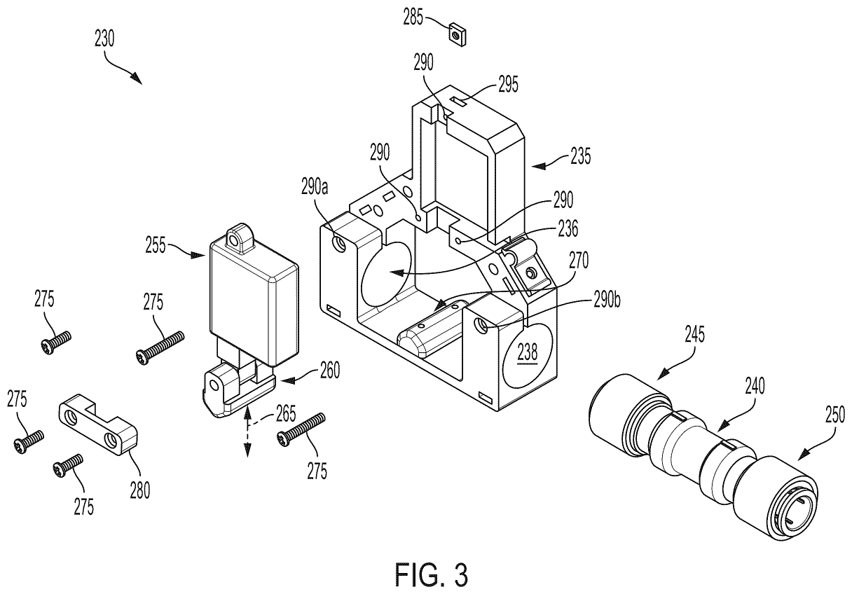

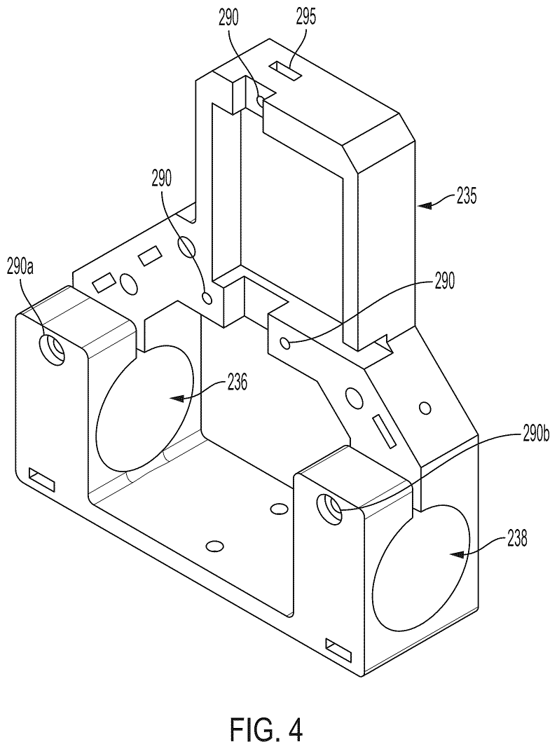

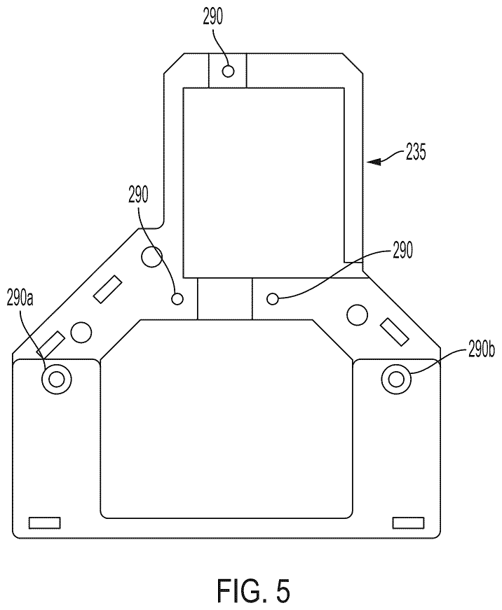

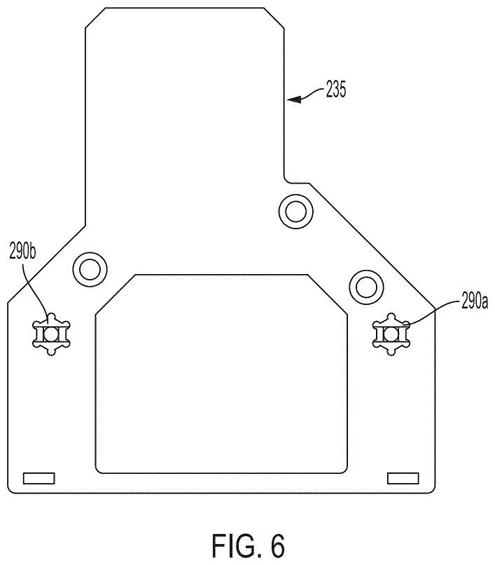

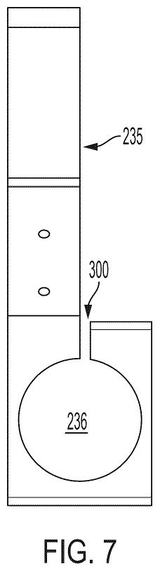

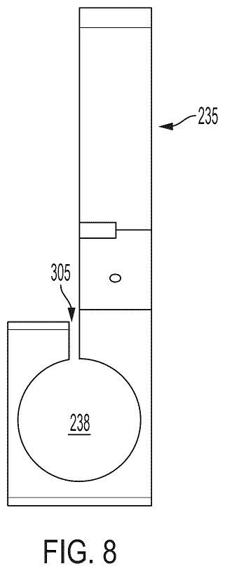

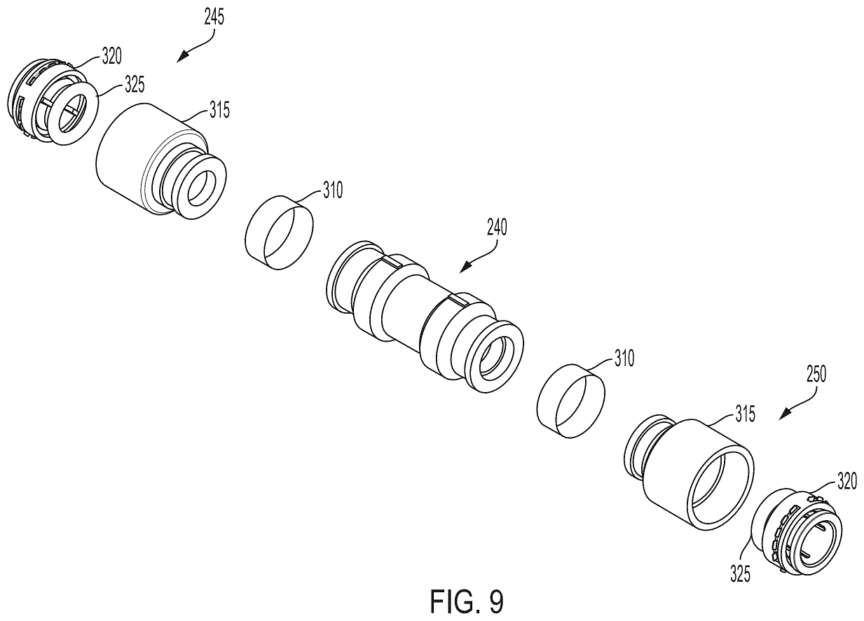

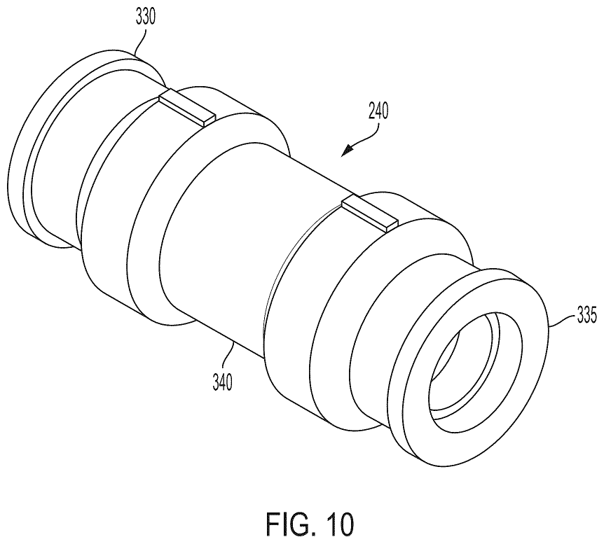

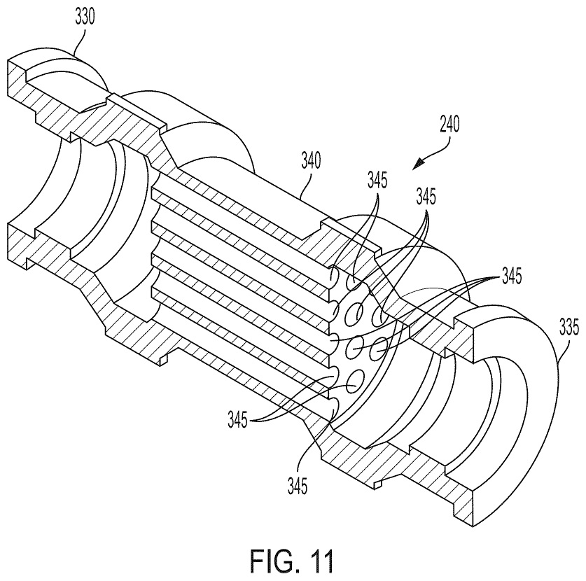

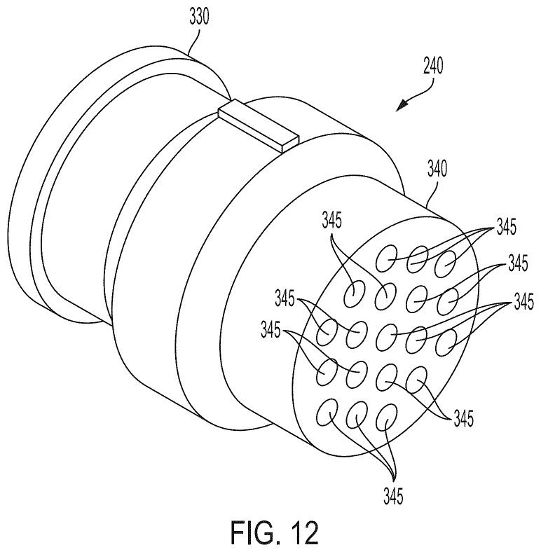

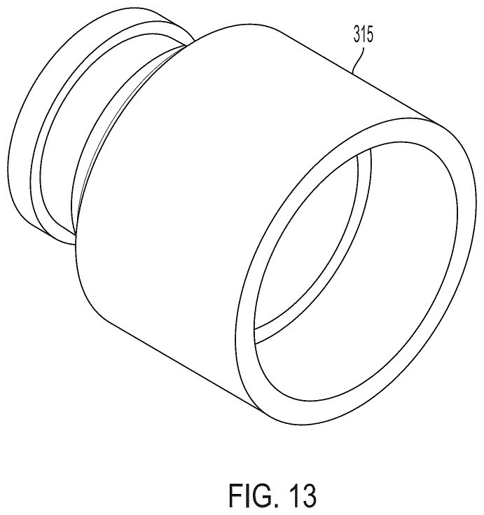

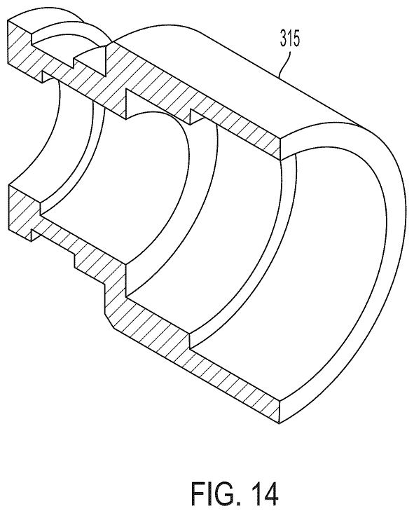

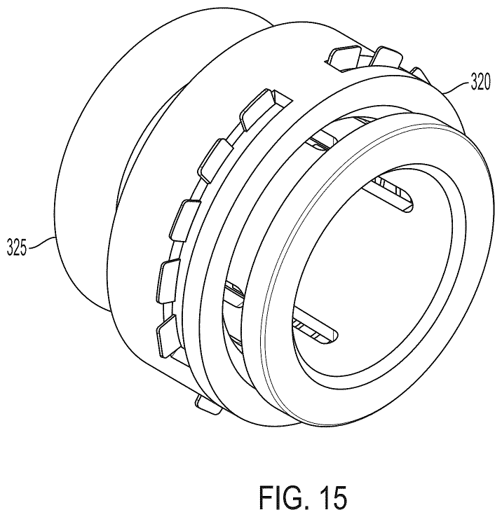

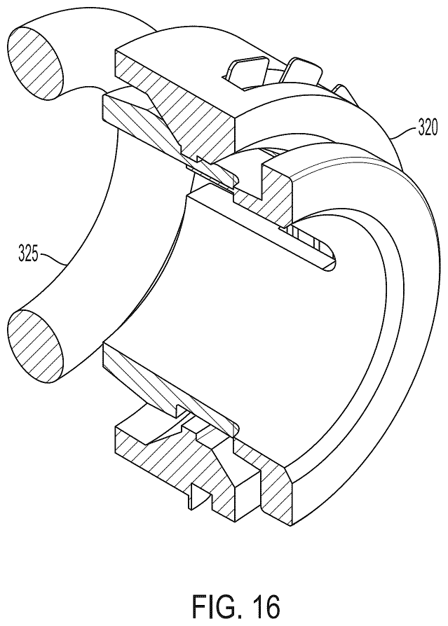

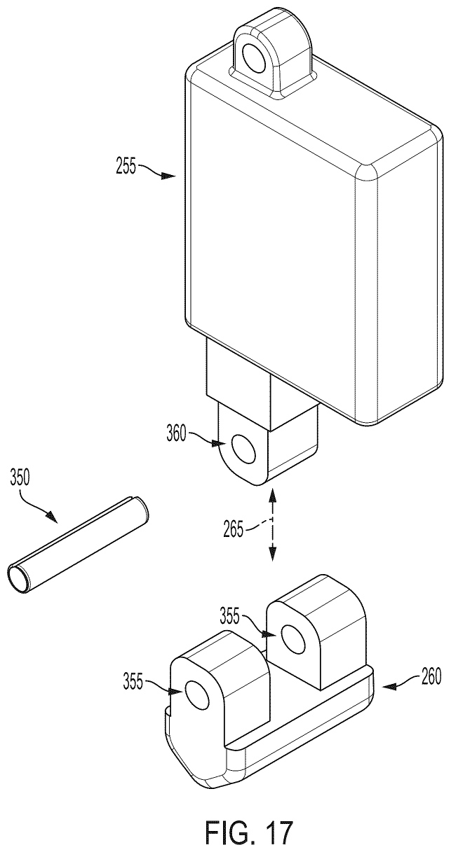

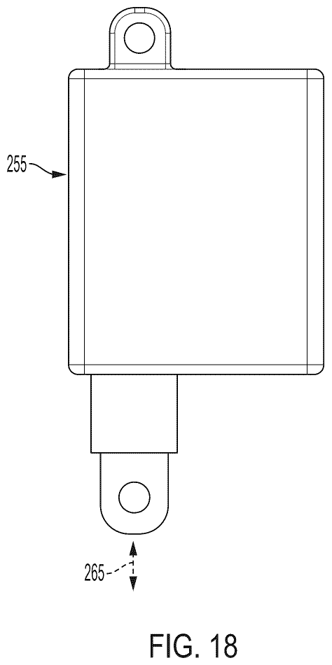

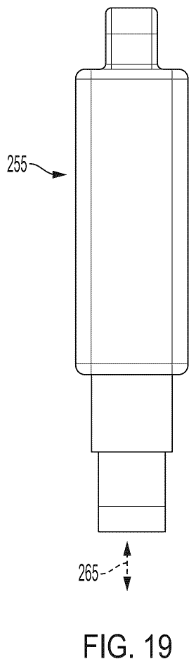

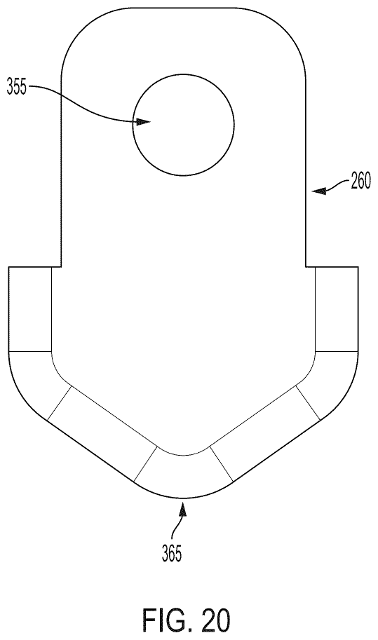

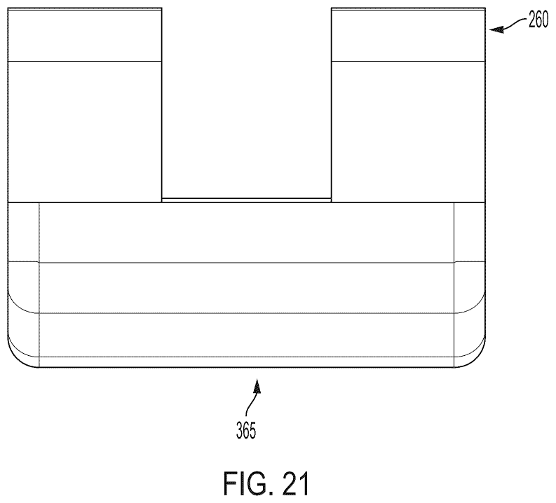

Referring to FIGS. 2-21 and continuing reference to FIG. 1, the patient simulator 100 includes one or more proportional valve assemblies 230. For example, FIG. 2 is a perspective view of a proportional valve assembly, according to one or more aspects of the present disclosure. FIG. 3 is an exploded view of the proportional valve assembly of FIG. 2, according to one or more aspects of the present disclosure. FIG. 4 is a perspective view of a mounting structure of the proportional valve assembly of FIGS. 2-3, according to one or more aspects of the present disclosure. FIG. 5 is a front view of the mounting structure of FIG. 4, according to one or more aspects of the present disclosure. FIG. 6 is a rear view of the mounting structure of FIGS. 4-5, according to one or more aspects of the present disclosure. FIG. 7 is an end view of the mounting structure of FIGS. 4-6, according to one or more aspects of the present disclosure. FIG. 8 is an end view of the mounting structure of FIGS. 4-7 from the opposite end of the view shown in FIG. 7, according to one or more aspects of the present disclosure. FIG. 9 is an exploded view of a valve connection assembly of the proportional valve assembly of FIGS. 2-3, according to one of more aspects of the present disclosure. FIG. 10 is a perspective view of a resiliently deformable valve of the valve connection assembly of FIG. 9, according to one of more aspects of the present disclosure. FIG. 11 is a perspective, longitudinal cross-sectional view of the resiliently deformable valve of FIG. 10, according to one of more aspects of the present disclosure. FIG. 12 is a perspective, cross-sectional view of the resiliently deformable valve of FIGS. 10-11, according to one of more aspects of the present disclosure. FIG. 13 is a perspective view of a connector of the valve connection assembly of FIG. 9, according to one of more aspects of the present disclosure. FIG. 14 is a perspective, longitudinal cross-sectional view of the connector of FIG. 13, according to one of more aspects of the present disclosure. FIG. 15 is a perspective view of a fitting and O-ring of the valve connection assembly of FIG. 9, according to one of more aspects of the present disclosure. FIG. 16 is a perspective, longitudinal cross-sectional view of the fitting and O-ring of FIG. 15, according to one of more aspects of the present disclosure. FIG. 17 is an exploded view of a linear displacement assembly of the proportional valve assembly of FIGS. 2-3, according to one of more aspects of the present disclosure. FIG. 18 is a front view of a linear displacement actuator of the linear displacement assembly of FIG. 17, according to one of more aspects of the present disclosure. FIG. 19 is a side view of the linear displacement actuator of FIG. 18, according to one of more aspects of the present disclosure. FIG. 20 is a side view of an engagement structure of the linear displacement assembly of FIG. 17, according to one of more aspects of the present disclosure. FIG. 21 is a front view of the engagement structure of FIG. 20, according to one of more aspects of the present disclosure.

As shown in FIGS. 2-3, the proportional valve assembly 230 includes a mounting structure 235, a resiliently deformable valve 240, a proximal connection assembly 245, a distal connection assembly 250, a linear actuator 255, an engagement structure 260 that moves a long a linear path 265, and an opposing engagement structure 270. As seen in FIG. 3, the mounting structure 235 includes openings 236 and 238 sized and shaped to receive the proximal connection assembly 245 and the distal connection assembly 250, respectively. A plurality of engagement bolts/screws 275, engagement structure(s) 280, nut(s) 285, and/or other engagement components may be utilized to secure the linear actuator 255 and/or the resiliently deformable valve 240 to the mounting structure 235, including via engagement with openings 290 and/or recess 295 of the mounting structure 235. In this regard, the resiliently deformable valve 240 may be secured to the to the mounting structure 235 by engagement of the proximal connection assembly 245 and the distal connection assembly 250 with the mounting structure 235. In some instances, the proximal connection assembly 245 is secured to the mounting structure 235 by an engagement bolt/screw 275 passing through opening 290a and compressing/closing the gap 300 associated with opening 236 (see, e.g., FIG. 7), which compresses the surrounding structure of the mounting structure to the proximal connection assembly 245. Similarly, the distal connection assembly 250 may be secured to the mounting structure 235 by an engagement bolt/screw 275 passing through opening 290b and compressing/closing the gap 305 associated with opening 238 (see, e.g., FIG. 8), which compresses the surrounding structure of the mounting structure to the distal connection assembly 250. The mounting structure 235 may include other openings, projections, and/or engagement features to facilitate coupling the mounting structure to the other components of the proportional valve assembly 230 and/or to other portions/parts of the patient simulator 100. Those of ordinary skill in the art will appreciate that various other arrangements and mechanisms may be used to couple the various components of the proportional valve assembly 230 to one another and/or other aspects of the patient simulator 100.

In use, the proportional valve assembly 230 utilizes the linear actuator 255 to control movement and positioning of the engagement structure 260 along the linear path 265. The position of the engagement structure 260 along the linear path 265 controls the amount of compression and/or deformation of the resiliently deformable valve 240 caused by the engagement structures 260 and 270. For example, as the engagement structure 260 is lowered towards the resiliently deformable valve 240 along the linear path 265 the engagement structure 260 compresses the resiliently deformable valve 240 into the opposing engagement structure 270 causing a plurality of openings (e.g., a capillary system) extending through the resiliently deformable valve 240 to be compressed, which can reduce the flow of fluids and/or gases through the resiliently deformable valve 240. On the other hand, as the engagement structure 260 is raised away from the resiliently deformable valve 240 along the linear path 265 the engagement structure 260 allows the resiliently deformable valve 240 to expand back towards its natural or default orientation allowing the plurality of openings extending through the resiliently deformable valve 240 to open to a greater extent (e.g., as compared to a more compressed state), which can increase the flow of fluids and/or gases through the resiliently deformable valve 240. In this regard, the proximal connection assembly 245 may function as an inlet and the distal connection assembly 250 may function as an outlet, or vice versa. In this regard, the proximal connection assembly 245 and/or the distal connection assembly 250 may be configured to couple the resiliently deformable valve 240 to tubes, pipes, connectors, or other mechanisms for linking the resiliently deformable valve 240 to one or more other components of the patient simulator 100, including without limitations simulated arteries, veins, vessels, lungs, organs, and/or other components.

In some aspects, the resiliently deformable valve provides a generally linear response in terms of the amount of fluid/gas flow to the amount of compression of the resiliently deformable valve 240. In this manner, controlling the position of the engagement structure 260 with the linear actuator 255 controls the flow of fluid/gas through the resiliently deformable valve 240 with a better range of control and with reduced turbulence and noise, including with lower power requirements, as compared to traditional needle valves. As a result, the proportional valve assemblies 230 of the present disclosure can provide more realistic simulations in the context of patient simulators by reducing and/or eliminating unwanted, unexpected, or unnatural noises and/or reduce power consumption (extending battery life and operating times for the patient simulator).

Referring to FIGS. 9-16, additional details of a valve connection assembly that includes the resiliently deformable valve 240, the proximal connection assembly 245, and the distal connection assembly 250 are shown. As shown the resiliently deformable valve 240 engages with the proximal connection assembly 245 and the distal connection assembly 250. In some instances, proximal connection assembly 245 and the distal connection assembly 250 have similar and/or the same structures such that the resiliently deformable valve 240 connects to each in a similar manner. For example, in some aspects a sleeve 310 is used to secure or lock the resiliently deformable valve to a connector 315 that is coupled to a fitting 320 and an associated O-ring 325. In some aspects, a male portion of the connector 315 is received within a female portion of the resiliently deformable valve 240 (e.g., cavities associated with the ends 330 and 335 of the resiliently deformable valve 240 (see, e.g., FIGS. 10-11) and the sleeve 310 secures the connection between the resiliently deformable valve 240 and the connector 315. As shown in FIGS. 10 and 11, the resiliently deformable valve 240 includes a central portion 340. A plurality of openings or passages 345 (e.g., forming a capillary system) extend along the length of the central portion 340. In use, the plurality of openings or passages 345 are selectively compressed to control the flow of fluids/gases through the resiliently deformable valve 240. For example, the force of the engagement structures 260 and 270 applied to the resiliently deformable valve 240 based on the position of the engagement structure 260 along the path 265 determines the amount of compression of the plurality of openings or passages 345 and the associated resistance to flow through the resiliently deformable valve 240. In this regard, the resiliently deformable valve 240 and, in particular, the central portion 340 may be formed of any suitable resiliently deformable material, including without limitation rubbers, silicones, plastics, and/or combinations thereof.

Referring to FIGS. 17-21, additional details of the linear actuator 255 and engagement structure 260 are shown. The linear actuator 255 may be any type of suitable actuator, including without limitation a motor, a stepper motor, electric actuator, pneumatic actuator, etc., suitable for translating the engagement structure 260 along the path 265. As shown in FIG. 17, the engagement structure 260 may be coupled to a drive shaft or drive mechanism of the linear actuator 255 by a locking pin 350 that passes through associated openings 355 of the engagement structure 260 and an opening 360 of the drive shaft/mechanism of the linear actuator 255. In this regard, the linear actuator may be configured to cause the engagement surface 365 (see, e.g., FIGS. 20-21) to selectively engage with the resiliently deformable valve 240 to varying degrees to control the flow of fluids/gases through the resiliently deformable valve 240 by moving engagement structure 260 along the path 265.

As described above, a proportional valve assembly may comprise a resiliently deformable valve with an inlet and an outlet, and a displacement assembly configured to selectively compress the resiliently deformable valve between the inlet and the outlet to control a flow of fluid and/or gas through the resiliently deformable valve. The resiliently deformable valve may be configured to provide a linear response in terms of the flow of the fluid and/or the gas to the amount of compression of the resiliently deformable valve. The resiliently deformable valve may include a plurality of openings extending along its length. The displacement assembly may be further configured to selectively compress the plurality of openings when compressing the resiliently deformable valve. The displacement assembly may comprise a linear actuator and an engagement structure. The linear actuator may be configured to control displacement of the engagement structure to selectively compress the plurality of openings through contact of the engagement structure with the resiliently deformable valve. The proportional valve assembly may further comprise a control unit in communication with the displacement assembly. The linear actuator may be controlled at least in part based on a communication from the control unit. Additionally, the proportional valve assembly may include a mounting structure to which the resiliently deformable valve and the displacement assembly are coupled. The mounting structure may include an additional engagement structure configured to compress the plurality of openings through contact of the additional engagement structure with the resiliently deformable valve opposite the engagement structure of the displacement assembly. The resiliently deformable valve can be formed of rubber, silicone, and/or other suitable resiliently deformable materials.

The present application further includes the following aspects:
1. A patient simulator, comprising:
   a simulated portion of a human body; and
   a proportional valve assembly positioned within the simulated portion of the human body, the proportional valve assembly including a resiliently deformable valve and a displacement assembly, wherein the displacement assembly is configured to selectively compress the resiliently deformable valve to control a flow of fluid and/or gas through the resiliently deformable valve.
2. The patient simulator of aspect 1, wherein the resiliently deformable valve is configured to provide a linear response in terms of the flow of the fluid and/or the gas through the resiliently deformable valve to the amount of compression of the resiliently deformable valve.
3. The patient simulator of any of aspects 1-2, wherein:
   the resiliently deformable valve includes a plurality of openings extending along a length of the resiliently deformable valve.
4. The patient simulator of aspect 3, wherein the displacement assembly is further configured to selectively compress the plurality of openings when compressing the resiliently deformable valve.
5. The patient simulator of aspect 4, wherein the displacement assembly comprises a linear actuator and an engagement structure, the linear actuator configured to control displacement of the engagement structure to selectively compress the plurality of openings through contact of the engagement structure with the resiliently deformable valve.
6. The patient simulator of aspect 5, further comprising:
   a control unit in communication with the displacement assembly, wherein the linear actuator is controlled at least in part based on a communication from the control unit.
7. The patient simulator of any of aspects 1-6, further comprising:
   a mounting structure to which the resiliently deformable valve and the displacement assembly are coupled.
8. The patient simulator of aspect 7, wherein the mounting structure includes an additional engagement structure configured to compress the plurality of openings through contact of the additional engagement structure with the resiliently deformable valve opposite the engagement structure of the displacement assembly.
9. The patient simulator of any of aspects 1-8, wherein the resiliently deformable valve is formed of a rubber.
10. The patient simulator of any of aspects 1-9, wherein the resiliently deformable valve is formed of a silicone.
11. A proportional valve assembly, comprising:
   a resiliently deformable valve comprising an inlet and an outlet; and
   a displacement assembly, wherein the displacement assembly is configured to selectively compress the resiliently deformable valve between the inlet and the outlet to control a flow of fluid and/or gas through the resiliently deformable valve.
12. The proportional valve assembly of aspect 11, wherein the resiliently deformable valve is configured to provide a linear response in terms of the flow of the fluid and/or the gas to the amount of compression of the resiliently deformable valve.
13. The proportional valve assembly of any of aspects 11-12, wherein:
   the resiliently deformable valve includes a plurality of openings extending along a length of the resiliently deformable valve.
14. The proportional valve assembly of aspect 13, wherein the displacement assembly is further configured to selectively compress the plurality of openings when compressing the resiliently deformable valve.
15. The proportional valve assembly of aspect 14, wherein the displacement assembly comprises a linear actuator and an engagement structure, the linear actuator configured to control displacement of the engagement structure to selectively compress the plurality of openings through contact of the engagement structure with the resiliently deformable valve.
16. The proportional valve assembly of aspect 15, further comprising:
   a control unit in communication with the displacement assembly, wherein the linear actuator is controlled at least in part based on a communication from the control unit.
17. The proportional valve assembly of any of aspects 11-16, further comprising:
   a mounting structure to which the resiliently deformable valve and the displacement assembly are coupled.
18. The proportional valve assembly of claim 17, wherein the mounting structure includes an additional engagement structure configured to compress the plurality of openings through contact of the additional engagement structure with the resiliently deformable valve opposite the engagement structure of the displacement assembly.
19. The proportional valve assembly of any of aspects 11-18, wherein the resiliently deformable valve is formed of a rubber.
20. The proportional valve assembly of any of aspects 11-19, wherein the resiliently deformable valve is formed of a silicone.
21. A method, comprising:
   selectively compressing a resiliently deformable valve positioned within a patient simulator to control a flow of fluid and/or gas through the resiliently deformable valve.
22. The method of aspect 21, wherein the resiliently deformable valve is configured to provide a linear response in terms of the flow of the fluid and/or the gas through the resiliently deformable valve to the amount of compression of the resiliently deformable valve.
23. The method of any of aspects 21-22, wherein:
   the resiliently deformable valve includes a plurality of openings extending along a length of the resiliently deformable valve such that the plurality of openings are compressed when the resiliently deformable valve is selectively compressed.
24. The method of any of aspects 21-23, wherein selectively compressing the resiliently deformable valve comprises controlling displacement of an engagement structure.
25. The method of aspect 24, wherein the displacement of the engagement structure is caused by a linear actuator coupled to the engagement structure.
26. The method of aspect 25, wherein the linear actuator is controlled at least in part based on a communication from a control unit.
27. The method of aspect 26, wherein the communication from the control unit is based, at least in part, on a medical simulation scenario associated with the patient simulator.
28. The method of any of aspects 21-27, wherein the selectively compressing the resiliently deformable valve is performed based on a medical simulation scenario being executed by the patient simulator.

Although illustrative embodiments have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the embodiment. Accordingly, it is appropriate that the appended claims be construed broadly and in a manner consistent with the scope of the present disclosure.

1. A patient simulator, comprising:
a simulated portion of a human body; and
a proportional valve assembly positioned within the simulated portion of the human body, the proportional valve assembly including a resiliently deformable valve and a displacement assembly, wherein the displacement assembly is configured to selectively compress the resiliently deformable valve to control a flow of fluid and/or gas through the resiliently deformable valve.

2. The patient simulator of claim 1, wherein the resiliently deformable valve is configured to provide a linear response in terms of the flow of the fluid and/or the gas through the resiliently deformable valve to an amount of compression of the resiliently deformable valve.

3. The patient simulator of claim 1, wherein:
the resiliently deformable valve includes a plurality of openings extending along a length of the resiliently deformable valve.

4. The patient simulator of claim 3, wherein the displacement assembly is further configured to selectively compress the plurality of openings when compressing the resiliently deformable valve.

5. The patient simulator of claim 4, wherein the displacement assembly comprises a linear actuator and an engagement structure, the linear actuator configured to control displacement of the engagement structure to selectively compress the plurality of openings through contact of the engagement structure with the resiliently deformable valve.

6. The patient simulator of claim 5, further comprising:
a control unit in communication with the displacement assembly, wherein the linear actuator is controlled at least in part based on a communication from the control unit.

7. The patient simulator of claim 5, further comprising:
a mounting structure to which the resiliently deformable valve and the displacement assembly are coupled.

8. The patient simulator of claim 7, wherein the mounting structure includes an additional engagement structure configured to compress the plurality of openings through contact of the additional engagement structure with the resiliently deformable valve opposite the engagement structure of the displacement assembly.

9. The patient simulator of claim 1, wherein the resiliently deformable valve is formed of a rubber.

10. The patient simulator of claim 1, wherein the resiliently deformable valve is formed of a silicone.

11. A proportional valve assembly, comprising:
a resiliently deformable valve comprising an inlet and an outlet; and
a displacement assembly, wherein the displacement assembly is configured to selectively compress the resiliently deformable valve between the inlet and the outlet to control a flow of fluid and/or gas through the resiliently deformable valve.

12. The proportional valve assembly of claim 11, wherein the resiliently deformable valve is configured to provide a linear response in terms of the flow of the fluid and/or the gas to an amount of compression of the resiliently deformable valve.

13. The proportional valve assembly of claim 11, wherein:
the resiliently deformable valve includes a plurality of openings extending along a length of the resiliently deformable valve.

14. The proportional valve assembly of claim 13, wherein the displacement assembly is further configured to selectively compress the plurality of openings when compressing the resiliently deformable valve.

15. The proportional valve assembly of claim 14, wherein the displacement assembly comprises a linear actuator and an engagement structure, the linear actuator configured to control displacement of the engagement structure to selectively compress the plurality of openings through contact of the engagement structure with the resiliently deformable valve.

16. The proportional valve assembly of claim 15, further comprising:
a control unit in communication with the displacement assembly, wherein the linear actuator is controlled at least in part based on a communication from the control unit.

17. The proportional valve assembly of claim 15, further comprising:
a mounting structure to which the resiliently deformable valve and the displacement assembly are coupled.

18. The proportional valve assembly of claim 17, wherein the mounting structure includes an additional engagement structure configured to compress the plurality of openings through contact of the additional engagement structure with the resiliently deformable valve opposite the engagement structure of the displacement assembly.

19. The proportional valve assembly of claim 11, wherein the resiliently deformable valve is formed of a rubber.

20. The proportional valve assembly of claim 11, wherein the resiliently deformable valve is formed of a silicone.
